(19) United States
(12) Patent Application Publication
(10) Pub. No.: US 2016/0032051 A1
(43) Pub. Date: Feb. 4, 2016

(54) Copolymerized Polyamide Resin, Method for Preparing the Same and Article Comprising the Same

(71) Applicant: Samsung SDI Co., Ltd., Yongin-si (KR)

(72) Inventors: So Young KWON, Uiwang-si (KR); Joon Sung KIM, Uiwang-si (KR); Eun Ju LEE, Uiwang-si (KR); Ki Yon LEE, Uiwang-si (KR); Sung Chul CHOI, Uiwang-si (KR)

(21) Appl. No.: 14/566,813

(22) Filed: Dec. 11, 2014

(30) Foreign Application Priority Data
Jul. 31, 2014 (KR) 10-2014-0098556

(51) Int. Cl. C08G 69/26; C08G 69/30

(52) U.S. Cl. CPC C08G 69/265; C08G 69/30

(57) ABSTRACT

A copolymerized polyamide resin includes a polymer of a monomer mixture comprising a dicarboxylic acid component and a diamine component including about 4 mol % to about 20 mol % of an alicyclic diamine represented by the Formula 1, wherein the polyamide resin has a melting temperature (Tm) from about 280 to about 330° C. and a crystallization temperature (Tc) from about 250 to about 300° C.:

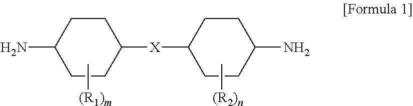

wherein, R₁ and R₂ are the same or different and are each independently a C₁ to C₅ alkyl group or a C₆ to C₁₀ aryl group, X is a C₁ to C₁₀ hydrocarbon group, and m and n are the same or different and are each independently an integer from 0 to 4. The copolymerized polyamide resin can exhibit excellent properties, such as crystallinity, heat resistance, processability and discoloration resistance, and an excellent balance therebetween.

### CROSS-REFERENCE TO RELATED APPLICATION

This application claims priority under 35 USC Section 119 to and the benefit of Korean Patent Application No. 10-2014-0098556, filed Jul. 31, 2014, the entire disclosure of which is incorporated herein by reference.

### FIELD OF THE INVENTION

The present invention relates to a copolymerized polyamide resin, a method for preparing the same, and a molded article including the same.

### BACKGROUND

High heat resistant nylon can be obtained by polycondensation of aromatic dicarboxylic acids or aromatic diamines. The high heat resistant nylon may have a semi-aromatic structure and a semi-crystalline structure, and may be used in various fields requiring high heat resistance due to its significantly higher heat resistance as compared to general nylon. The high heat resistant nylon has variable physical properties, such as heat resistance, fluidity, and the like depending on comonomers and copolymerization ratios.

Examples of typical high heat resistant nylon include PA4T, PA6T, PA9T, PA10T, PA11T, PA12T, and the like. Generally, PA4T and PA6T, having a few carbon atoms of a linear alkylene group in the main chain, cannot be processed due to an extremely high melting temperature of the homopolymer. Thus, melt processability thereof can be improved by introduction of a large amount of (tens of %) comonomers.

For example, for PA6T, adipic acid, and the like are widely used as a comonomer. The high heat resistant nylon, however, is likely to degrade via a known mechanism, i.e., cyclization reaction at a high temperature when using a dicarboxylic acid comprising a linear aliphatic dicarboxylic acid, such as adipic acid, and the like as the comonomer. See, for example, Archamer B G, Reinhard F W and Kline G M, J Res Natl Bur Stand 4:391 (1951).

Korean Patent Publication No. 10-2007-0049979 describes the use of an alicyclic diamine such as bis(p-amino-3-methyl-cyclohexyl)methane (MACM) to increase heat resistance (glass transition temperature) of the nylon. In above patent, the polyamide resin has excellent heat resistance and a glass transition temperature (Tg) of no less than about 210° C. The resin, however, is not a crystalline but amorphous polyamide resin. In other words, the polyamide resin prepared from an alicyclic diamine is typically used in amorphous products or products having a low crystallinity.

Therefore, there is a need for a crystalline copolymerized polyamide resin, with improved properties, such as heat resistance, (melt) processability, discoloration resistance, and the like, an excellent balance therebetween, and which can be used in LED reflector, and the like without decomposing by the comonomers.

### SUMMARY

The present invention can provide a crystalline copolymerized polyamide resin having excellent properties, such as heat resistance, processability and discoloration resistance and an excellent balance therebetween by using an alicyclic diamine comprising two cyclohexyl groups, a method for preparing the same, and a molded article including the same.

The copolymerized polyamide resin is a polymer of a monomer mixture comprising a dicarboxylic acid component and a diamine component including about 4 mol % to about 20 mol % of an alicyclic diamine represented by the Formula 1, wherein the polyamide resin has a melting temperature (Tm) from about 280 to about 330° C., and a crystallization temperature (Tc) from about 250 to about 300° C.:

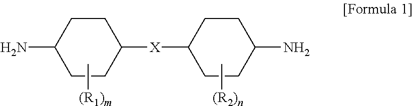

wherein, R₁ and R₂ are the same or different and are each independently a C₁ to C₅ alkyl group or a C₆ to C₁₀ aryl group, X is a C₁ to C₁₀ hydrocarbon group, and m and n are the same or different and are each independently an integer from 0 to 4.

In one embodiment, the dicarboxylic acid component may comprise at least one of a C₈ to C₂₀ aromatic dicarboxylic acid and/or a C₆ to C₂₀ alicyclic dicarboxylic acid.

In one embodiment, the diamine component may comprise at least one of C₄ to C₂₀ linear and/or branched aliphatic diamines.

In one embodiment, the alicyclic diamine represented by the Formula 1 may include a trans-trans isomer in an amount of about 15 to about 55 wt %, a trans-cis isomer in an amount of about 30 to about 55 wt %, and a cis-cis isomer in an amount of no more than about 35 wt %.

In one embodiment, the copolymerized polyamide resin may have a mole ratio of the dicarboxylic acid component and the diamine component (dicarboxylic acid component/diamine component) from about 0.95 to about 1.15.

In one embodiment, the copolymerized polyamide resin may have a terminal group encapsulated with an end capping agent comprising at least one of an aliphatic carboxylic acid and/or an aromatic carboxylic acid.

In one embodiment, the copolymerized polyamide resin may have a glass transition temperature (Tg) from about 105 to about 135° C., a melt enthalpy from about 20 to about 100 J/g, and a crystallization enthalpy from about 20 to about 60 J/g.

In one embodiment, the copolymerized polyamide resin may have an intrinsic viscosity from about 0.5 to about 1.5 dL/g, and a Yellowness Index change (ΔYI) according to Equation 1 from about 4 to about 12:

Color change (ΔYI)=YI after scorch testing−YI before scorch testing, [Equation 1]

wherein YI before scorch testing is a Yellowness Index (YI) value of the prepared copolymerized polyamide resin measured according to ASTM D1209, and YI after scorch testing is a YI value of the copolymerized polyamide resin after scorch testing conducted by leaving the copolymerized polyamide resin in a convection oven at about 200° C. for about 1 hour.

The present invention also relates to a method for preparing the copolymerized polyamide resin. The method includes: polymerizing a monomer mixture comprising a dicarboxylic acid component and a diamine component including about 4 mol % to about 20 mol % of an alicyclic diamine represented by Formula 1, wherein the polyamide resin has a melting temperature (Tm) from about 280 to about 330° C., and a crystallization temperature (Tc) from about 250 to about 300° C.

In one embodiment, the method may comprise polymerizing the monomer mixture to obtain a prepolymer; and performing a solid state polymerization of the prepolymer.

In one embodiment, the solid state polymerization may comprise heating the prepolymer to a temperature of about 150 to about 280° C.

The present invention further relates to a molded article produced from the copolymerized polyamide resin.

In exemplary embodiments, the molded article may be an LED reflector, a connector of electrical and electronic products, and/or an exterior cladding of electrical and electronic products.

### DETAILED DESCRIPTION

Exemplary embodiments now will be described more fully hereinafter in the following detailed description, in which some, but not all embodiments of the invention are described. Indeed, this invention may be embodied in many different forms and should not be construed as limited to the embodiments set forth herein; rather, these embodiments are provided so that this disclosure will satisfy applicable legal requirements.

A copolymerized polyamide resin according to the present invention includes a polymer of a monomer mixture comprising (A) a dicarboxylic acid component, and (B) a diamine component including about 4 mol % to about 20 mol % of (b1) an alicyclic diamine represented by Formula 1, wherein the polyamide resin has a melting temperature (Tm) from about 280 to about 330° C. and a crystallization temperature (Tc) from about 250 to about 300° C.

As used herein, the term “dicarboxylic acid (component)” refers to dicarboxylic acids, alkyl esters thereof (C₁ to C₄ lower alkyl esters, such as monomethyl, monoethyl, dimethyl, diethyl, dibutyl esters, and the like), acid anhydrides thereof, and the like, and forms the dicarboxylic acid moieties through a reaction with a diamine (component). In addition, as used herein, the dicarboxylic acid moieties and the diamine moieties mean residues remaining after removal of hydrogen atoms, hydroxyl groups or alkoxy groups upon polymerization of the dicarboxylic acid component and the diamine component.

(A) Dicarboxylic Acid Component

The dicarboxylic acid component used in the present invention may comprise (a1) an aromatic dicarboxylic acid and/or (a2) an alicyclic dicarboxylic acid used typically in the polyamide resin. For example, the dicarboxylic acid component may comprise at least one of a C₈ to C₂₀ aromatic dicarboxylic acid and/or a C₆ to C₂₀ alicyclic dicarboxylic acid.

Examples of the aromatic dicarboxylic acid may include, without limitation, terephthalic acid, isophthalic acid, 2,6-naphthalene dicarboxylic acid, 2,7-naphthalene dicarboxylic acid, 1,4-naphthalene dicarboxylic acid, 1,4-phenylene dioxydiphenolic acid, 1,3-phenylene dioxydiacetic acid, diphenic acid, 4,4′-oxybis(benzoic acid), diphenylmethane-4,4′-dicarboxylic acid, diphenylsulfone-4,4′-dicarboxylic acid, 4,4′-diphenyldicarboxylic acid, and the like, and mixtures thereof. For example, the aromatic dicarboxylic acid may include terephthalic acid, isophthalic acid, or a mixture thereof. The copolymerized polyamide resin may exhibit excellent heat resistance, crystallinity, and the like when comprising the aromatic dicarboxylic acid.

Examples of the alicyclic dicarboxylic acid may include, without limitation, 1,4-cyclohexanedicarboxylic acid, 1,1-cyclobutanedicarboxylic acid, 1,2-cyclobutanedicarboxylic acid, 1,3-cyclohexanedicarboxylic acid, 1,3-cyclopentanedicarboxylic acid, 1,2-cyclopentanedicarboxylic acid, 1,5-cyclooctanedicarboxylic acid, and mixtures thereof. For example, the alicyclic dicarboxylic acid may include 1,4-cyclohexanedicarboxylic acid, 1,3-cyclohexanedicarboxylic acid, 1,3-cyclopentanedicarboxylic acid, 1,2-cyclopentanedicarboxylic acid, 1,5-cyclooctanedicarboxylic acid, and mixtures thereof. The copolymerized polyamide resin may exhibit excellent heat resistance, crystallinity, discoloration resistance, and the like when comprising the alicyclic dicarboxylic acid.

In addition, the dicarboxylic acid according to the present invention may further include (a3) a linear and/or branched aliphatic dicarboxylic acid to further increase the processability of the copolymerized polyamide resin. Examples of the linear and/or branched aliphatic dicarboxylic acid may include, without limitation, C₆ to C₁₂ linear and/or branched aliphatic dicarboxylic acids, for example, adipic acid.

The dicarboxylic acid component may include the linear and/or branched aliphatic dicarboxylic acid in an amount of about 30 mol % or less, for example, about 20 mol % or less, based on the total mol % (100 mol %) of the dicarboxylic acid component. In some embodiments, the dicarboxylic acid component may include the linear and/or branched aliphatic dicarboxylic acid in an amount of 0 (the linear and/or branched aliphatic dicarboxylic acid is not present), about 0 (the linear and/or branched aliphatic dicarboxylic acid is present), 1, 2, 3, 4, 5, 6, 7, 8, 9, 10, 11, 12, 13, 14, 15, 16, 17, 18, 19, 20, 21, 22, 23, 24, 25, 26, 27, 28, 29, or 30 mol %. Further, according to some embodiments of the present invention, the amount of the linear and/or branched aliphatic dicarboxylic acid can be in a range from about any of the foregoing amounts to about any other of the foregoing amounts.

When the copolymerized polyamide resin includes a linear and/or branched aliphatic dicarboxylic acid in an amount within the above range, the copolymerized polyamide resin is capable of diminishing or preventing the phenomenon of gas generation during high temperature processing of the polyamide resin while having excellent processability.

(B) Diamine Component

The diamine component (B) used in the present invention may include about 4 mol % to about 20 mol %, for example, about 5 mol % to about 15 mol %, of (b1) the alicyclic diamine by represented by Formula 1:

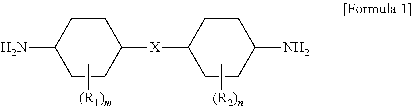

wherein, R₁ and R₂ are the same or different and are each independently a C₁ to C₅ alkyl group or a C₆ to C₁₀ aryl group, X is a C₁ to C₁₀ hydrocarbon group, for example, a C₁ to C₁₀ linear and/or branched aliphatic hydrocarbon group and/or a C₆ to C₁₀ alicyclic hydrocarbon group, and as another example methylene, ethylene, propylene, cyclohexylene, and the like, and m and n are the same or different and are each independently an integer from 0 to 4.

Examples of alicyclic diamine may include, without limitation, bis(p-aminocyclohexyl)methane (PACM), bis(p-amino-3-methyl-cyclohexyl)methane (MACM), and the like, and mixtures thereof.

In some embodiments, the diamine component may include the alicyclic diamine represented by Formula 1 in an amount of about 4, 5, 6, 7, 8, 9, 10, 11, 12, 13, 14, 15, 16, 17, 18, 19, or 20 mol %, based on the total mol % (100 mol %) of the diamine component. Further, according to some embodiments of the present invention, the amount of the alicyclic diamine represented by Formula 1 can be in a range from about any of the foregoing amounts to about any other of the foregoing amounts.

If the alicyclic diamine is present in an amount of less than about 4 mol % of the total diamine components, the polyamide resin may have increased melting temperature, decreased processability, and decreased heat discoloration resistance. If the alicyclic diamine is present in an amount of more than about 20 mol %, the crystallinity of the polyamide resin may be lowered, the crystallization rate may become slow, and process time may increase.

In one embodiment, the alicyclic diamine represented by Formula 1 may include, based on the amine group (—NH2), the trans-trans isomer in an amount of about 15 to about 55 wt %, for example, about 20 to about 55 wt %, the trans-cis isomer in an amount of about 30 to about 55 wt %, for example, about 35 to about 55 wt %, and the cis-cis isomer in an amount of about 35 wt % or less, for example, about 30 wt % or less.

In some embodiments, the alicyclic diamine represented by Formula 1 may include the trans-trans isomer in an amount of about 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, or 55 wt %. Further, according to some embodiments of the present invention, the amount of the trans-trans isomer can be in a range from about any of the foregoing amounts to about any other of the foregoing amounts.

In some embodiments, the alicyclic diamine represented by Formula 1 may include the trans-cis isomer in an amount of about 30, 31, 32, 33, 34, 35, 36, 37, 38, 39, 40, 41, 42, 43, 44, 45, 46, 47, 48, 49, 50, 51, 52, 53, 54, or 55 wt %. Further, according to some embodiments of the present invention, the amount of the trans-cis isomer can be in a range from about any of the foregoing amounts to about any other of the foregoing amounts.

In some embodiments, the alicyclic diamine represented by Formula 1 may include the cis-cis isomer in an amount of 0 (the cis-cis isomer is not present), about 0 (the cis-cis isomer is present), 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, or 35 wt %. Further, according to some embodiments of the present invention, the amount of the cis-cis isomer can be in a range from about any of the foregoing amounts to about any other of the foregoing amounts.

The alicyclic diamine having such isomer contents may be obtained via the hydrogenation of methylenedianilline, or may use commercial products, for example, PACM50 or PACM20 from QQCHEM. The polyamide resins may have excellent processability, discoloration resistance (heat discoloration resistance), and the like when the polyamide resin includes the above-mentioned isomers in the amounts noted herein.

The diamine component (B) in the present invention may comprise about 80 mol % to about 96 mol %, for example, from about 85 mol % to about 95 mol % of (b2) an aliphatic diamine typically used in polyamide resins in addition to the alicyclic diamine. In some embodiments, the diamine component (B) may include (b2) the aliphatic diamine in an amount of about 80, 81, 82, 83, 84, 85, 86, 87, 88, 89, 90, 91, 92, 93, 94, 95, or 96 mol %. Further, according to some embodiments of the present invention, the amount of (b2) the aliphatic diamine can be in a range from about any of the foregoing amounts to about any other of the foregoing amounts.

The aliphatic diamine (b2) may comprise at least one of C₄ to C₂₀ linear and/or branched aliphatic diamine Examples of the C₄ to C₂₀ linear and/or branched aliphatic diamine may include, without limitation, 1,4-butanediamine, 1,6-hexanediamine (hexamethylene diamine: HMDA), 1,7-heptanediamine, 1,8-octanediamine, 1,10-decanediamine (decanediamine: DDA), 1,12-dodecanediamine (dodecanediamine: DDDA), 3-methyl-1,5-pentanediamine, 2,2,4-trimethyl-1,6-hexanediamine, 2,4,4-trimethyl-1,6-hexanediamine, 5-methyl-1,9-nonanediamine, 2,2-oxybis(ethylamine), bis(3-aminopropyl)ether, ethylene glycol bis(3-aminopropyl)ether (EGBA), 1,7-diamino-3,5-dioxoheptane, and the like and mixtures thereof.

Further, the diamine component (B) may further comprise (b3) an aromatic diamine to increase the heat resistance, crystallinity, and the like of the copolymerized polyamide resins.

The aromatic diamine may comprise at least one of C₆ to C₃₀ aromatic diamine. Examples of the C₆ to C₃₀ aromatic diamine may include, without limitation, a phenylenediamine compound, such as m-phenylenediamine, p-phenylenediamine, and the like, a xylenediamine compound, such as m-xylenediamine, p-xylenediamine, and the like, a naphthalenediamine compound, and the like, and mixtures thereof.

The diamine component (B) may include (b3) the aromatic diamine in an amount of about 30 mol % or less, for example, from about 1 to about 20 mol %, based on the total mol % (100 mol %) of the diamine component. In some embodiments, the diamine component (B) may include (b3) the aromatic diamine in an amount of 0 (the aromatic diamine is not present), about 0 (the aromatic diamine is present), 1, 2, 3, 4, 5, 6, 7, 8, 9, 10, 11, 12, 13, 14, 15, 16, 17, 18, 19, 20, 21, 22, 23, 24, 25, 26, 27, 28, 29, or 30 mol %. Further, according to some embodiments of the present invention, the amount of (b3) the aromatic diamine can be in a range from about any of the foregoing amounts to about any other of the foregoing amounts.

When the copolymerized polyamide resin includes the aromatic diamine in an amount within the above range, the copolymerized polyamide resin may exhibit excellent heat resistance, crystallinity, and the like.

The copolymerized polyamide resin according to the present invention may have a mole ratio of the dicarboxylic acid component (A) and the diamine component (B)((A)/(B)) from about 0.95 to about 1.15, for example, from about 1.0 to about 1.10. The deterioration of physical properties by the unreacted monomers can be prevented within this range.

In one embodiment, the copolymerized polyamide resin may have a terminal group encapsulated with an end capping agent including at least one of an aliphatic carboxylic acid and/or an aromatic carboxylic acid. Examples of the end capping agent may include, without limitation, acetic acid, propionic acid, butyric acid, valeric acid, caproic acid, caprylic acid, lauric acid, tridecanoic acid, myristic acid, palmitic acid, stearic acid, pivalic acid, isobutyric acid, benzoic acid, toluic acid, a-naphthalene carboxylic acid, β-naphthalene carboxylic acid, methylnaphthalene carboxylic acid, and the like, and mixtures thereof. In one embodiment, the end capping agent may be present in an amount from about 0.01 to about 5 parts by mole, for example, from about 0.1 to about 3 parts by mole, based on 100 parts by mole of the dicarboxylic acid component (A) and the diamine component (B).

The copolymerized polyamide resin of the present invention may be prepared according to conventional processes known in the art for preparing polyamide, for example, by polymerizing the monomer mixture comprising the dicarboxylic acid component and the diamine component.

The polymerization may be performed by a conventional polymerization method, for example, a melt polymerization method, wherein the polymerization temperature may range from about 80 to about 300° C., for example, from about 90 to about 280° C., and the polymerization pressure may range from about 10 to about 40 kgf/cm², without being limited thereto.

In one embodiment, the copolymerized polyamide resin may be prepared by polymerizing the monomer mixture to obtain a prepolymer; and performing a solid state polymerization of the prepolymer. In one embodiment, the copolymerized polyamide resin may be obtained by a process including: placing the monomer mixture, a catalyst and water in a reactor, stirring at a temperature of about 80 to about 190° C. for about 0.5 to about 2 hours, maintaining the mixture at about 200 to about 280° C. under a pressure of about 20 to about 40 kgf/cm² for about 2 to about 4 hours, lowering the pressure to about 10 to about 30 kgf/cm² and performing the reaction (copolymerization) for about 1 to about 3 hours to obtain a polyamide prepolymer, and performing a solid state polymerization of the prepolymer at a temperature between a glass transition temperature (Tg) and a melting temperature (Tm) in a vacuum for about 10 to about 30 hours.

The prepolymer may have an intrinsic viscosity [η] from about 0.1 dL/g to about 2.0 dL/g, for example, from about 0.5 dL/g to about 1.5 dL/g, as measured in a 98% sulfuric acid solution at 25° C. using an Ubbelohde viscometer. Within this range, the copolymerized polyamide resin may exhibit an excellent melt processability.

In one embodiment, the solid state polymerization comprises heating the prepolymer to a temperature of about 150 to about 280° C., for example, about 180 to about 250° C., in a vacuum or in the presence of an inert gas, such as nitrogen, argon, etc. Within this range, the copolymerized polyamide resin may have a weight average molecular weight of about 5,000 to about 50,000 g/mol.

A catalyst may be used in the copolymerization reaction. The catalyst may be a phosphorus catalyst. Examples of the phosphorous catalyst may include, without limitation, phosphoric acid, phosphorous acid, hypophosphorous acid, salts thereof, derivatives thereof, and the like. In specific examples, the catalyst may include phosphoric acid, phosphorous acid, hypophosphorous acid, sodium hypophosphate, sodium hypophosphinate, and the like.

The catalyst may be optionally present in an amount of about 3 parts by weight or less, for example, from about 0.001 parts by weight to about 1 part by weight, and as another example from about 0.01 parts by weight to about 0.5 parts by weight, based on about 100 parts by weight of the total monomer mixture, without being limited thereto.

Further, in the process for preparing the polyamide resin, the end capping agent may be used in an amount as described above, and the viscosity of the prepared copolymerized polyamide resin may be adjusted by adjusting the amount of the end capping agent.

The copolymerized polyamide resin of the present invention may have a melting temperature (Tm) from about 280 to about 330° C., for example, from about 285 to about 325° C., and a crystallization temperature (Tc) from about 250 to about 300° C., for example, from about 255 to about 295° C.

If the copolymerized polyamide resin has a melting temperature of less than about 280° C., the polyamide resin may have poor heat resistance, and if the copolymerized polyamide resin has a melting temperature of more than about 330° C., the polyamide resin may have poor processability. If the copolymerized polyamide resin has a crystallization temperature of less than about 250° C., the polyamide resin can suffer from a decrease in a crystallization speed and can have deteriorated moldability. If the copolymerized polyamide resin has a crystallization temperature of more than about 300° C., the moldability of the copolymerized polyamide resin may be deteriorated such that the injection molding conditions can become complicated and, when injection molding small parts, it may be difficult to eject the molded parts. The crystalline copolymerized polyamide resin having excellent processability may be obtained at the crystallization temperature from about 250 to about 300° C.

Further, the copolymerized polyamide resin may have a ratio (Tm/Tc) of the melting temperature (Tm) to the crystallization temperature (Tc) from about 1.08 to about 1.32, for example, about 1.10 to about 1.23. Within this range, the copolymerized polyamide resin may exhibit a much more excellent moldability.

In one embodiment, the copolymerized polyamide resin may have a glass transition temperature (Tg) from about 105 to about 135° C., for example, from about 106 to about 130° C. Within this range, the copolymerized polyamide resin may exhibit excellent heat resistance.

The copolymerized polyamide resin may have a melt enthalpy from about 20 to about 100 J/g, for example, from about 30 to about 95 J/g as measured using DSC. Within this range, the copolymerized polyamide resin may exhibit excellent moldability.

The copolymerized polyamide resin may have a crystallization enthalpy from about 20 to about 60 J/g, for example, from about 30 to about 55 J/g as measured using DSC. Within this range, the copolymerized polyamide resin may exhibit excellent (injection) processability and an increased processing rate.

The copolymerized polyamide resin may have an intrinsic viscosity from about 0.1 dL/g to about 2.0 dL/g, for example, from about 0.5 dL/g to about 1.5 dL/g, as measured in a conc. sulfuric acid solution (about 98%) at 25° C. using an Ubbelohde viscometer. Within this range, the copolymerized polyamide resin may exhibit an excellent moldability.

Further, the copolymerized polyamide resin may have a weight average molecular weight from about 5,000 g/mol to about 50,000 g/mol as measured by a gel permeation chromatography (GPC).

In one embodiment, the discoloration resistance (heat discoloration resistance) of the copolymerized polyamide resin may be determined by measuring a Yellowness Index (YI) of the prepared resin according to ASTM D1209, leaving the copolymerized polyamide resin in a convection oven at about 200° C. for about 1 hour (scorch testing), measuring the Yellowness Index in the same manner, and evaluating the Yellowness Index change (ΔYI) represented by Equation 1. The copolymerized polyamide resin may have a Yellowness Index change (ΔYI) from about 4 to about 12.

Color change (ΔYI)=YI after scorch testing−YI before scorch testing, [Equation 1]

wherein YI before scorch testing is a Yellowness Index (YI) value of the prepared copolymerized polyamide resin measured according to ASTM D1209, and YI after scorch testing is a YI value of the copolymerized polyamide resin after scorch testing conducted by leaving the copolymerized polyamide resin in a convection oven at about 200° C. for about 1 hour.

A molded article according to the present invention may be prepared from the copolymerized polyamide resin. For example, a copolymerized polyamide resin may be used for the preparation of an LED reflector, a connector of electrical and electronic products, and/or an exterior cladding of electrical and electronic products requiring heat resistance, processability, discoloration resistance, and the like, without being limited thereto. The molded article can be readily produced using conventional processes by those skilled in the art.

Next, the present invention will be explained in more detail with reference to the following examples. However, it should be understood that these examples are provided for illustration only and are not to be in any way construed as limiting the present invention.

### EXAMPLES

### Example 1

According to the composition as listed in Table 1, a monomer mixture comprising 99.68 g of terephthalic acid (TPA) as a dicarboxylic acid component (diacid), and 12.81 g of bis(p-aminocyclohexyl)methane (PACM50), having a content of the trans-trans isomer of 50.7 wt %, a content of the trans-cis isomer of 38.4 wt %, and a content of the cis-cis isomer of 10.9 wt %, and 94.44 g of 1,10-decanediamine (DDA) as a diamine component (diamine), 2.20 g of benzoic acid as an end capping agent, 0.21 g of sodium hypophosphate as a catalyst and 140 ml of distilled water are placed in a 1 L autoclave, which in turn is filled with nitrogen. Next, after stirring the components at 130° C. for 60 minutes, the mixture is heated to 250° C. for 2 hours and left for 3 hours at a pressure of 25 kgf/cm², followed by decreasing the pressure to 15 kgf/cm² and reacting the mixture for 1 hour. After flashing the mixture, it is separated into water and a polyamide pre-copolymer. The separated polyamide pre-copolymer (intrinsic viscosity [η]=about 0.2 dL/g) is put into a tumbler type reactor, and is subject to the solid state polymerization at 230° C. for 6 hours. Then, the polyamide pre-copolymer is cooled slowly to ambient temperature to obtain a copolymerized polyamide resin.

### Example 2

According to the composition as listed in Table 1, a copolymerized polyamide resin is prepared in the same manner as in Example 1 except that 109.82 g of 1,12-dodecanediamine (DDDA) instead of 94.44 g of 1,10-decanediamine (DDA) as the diamine component, 2.08 g of benzoic acid as the end capping agent, 0.22 g of sodium hypophosphate as the catalyst and 150 ml of distilled water are used, respectively.

### Example 3

According to the composition as listed in Table 1, a copolymerized polyamide resin is prepared in the same manner as in Example 1 except that 14.52 g of bis(p-amino-3-methyl-cyclohexyl)methane (MACM) having a content of trans-trans isomer of 44.5 wt %, a content of trans-cis isomer of 45.2 wt %, and a content of cis-cis isomer of 10.3 wt % instead of 12.81 g of bis(p-aminocyclohexyl)methane (PACM50) as the diamine component, and 2.32 g of benzoic acid as the end capping agent are used, respectively.

### Example 4

According to the composition as listed in Table 1, a copolymerized polyamide resin is prepared in the same manner as in Example 1 except that 103.31 g of 1,4-cyclohexanedicarboxylic acid (CHDA) instead of 99.68 g of terephthalic acid (TPA) as the dicarboxylic acid component, 109.82 g of 1,12-dodecanediamine (DDDA) instead of 94.44 g of 1,10-decanediamine (DDA) as the diamine component, and 2.08 g of benzoic acid as the end capping agent are used, respectively.

### Example 5

According to the composition as listed in Table 1, a copolymerized polyamide resin is prepared in the same manner as in Example 1 except that 103.31 g of 1,4-cyclohexanedicarboxylic acid (CHDA) instead of 99.68 g (0.6 mol) of terephthalic acid (TPA) as the dicarboxylic acid component, 6.41 g of bis(p-aminocyclohexyl)methane (PACM50) and 115.92 g of 1,12-dodecanediamine (DDDA) as the diamine component, and 2.08 g of benzoic acid as the end capping agent are used, respectively.

### Example 6

According to the composition as listed in Table 1, a copolymerized polyamide resin is prepared in the same manner as in Example 1 except that 103.31 g of 1,4-cyclohexanedicarboxylic acid (CHDA) instead of 99.68 g (0.6 mol) of terephthalic acid (TPA) as the dicarboxylic acid component, and 12.81 g of bis(p-aminocyclohexyl)methane (PACM20) having a content of trans-trans isomer of 22.1 wt %, a content of trans-cis isomer of 49.8 wt %, and a content of cis-cis isomer of 28.1 wt % and 109.82 g of 1,12-dodecanediamine (DDDA) as the diamine component are used, respectively.

### Example 7

According to the composition as listed in Table 1, a copolymerized polyamide resin is prepared in the same manner as in Example 1 except that 12.81 g of bis(p-aminocyclohexyl)methane (PACM20) and 109.82 g of 1,12-dodecanediamine (DDDA) as the diamine component are used, respectively.

### Example 8

According to the composition as listed in Table 1, a copolymerized polyamide resin is prepared in the same manner as in Example 1 except that 19.22 g of bis(p-aminocyclohexyl)methane (PACM50) and 89.20 g of 1,10-decanediamine (DDA) as the diamine component are used, respectively.

### Example 9

According to the composition as listed in Table 1, a copolymerized polyamide resin is prepared in the same manner as in Example 1 except that 9.97 g of terephthalic acid (TPA) and 92.98 g of 1,4-cyclohexanedicarboxylic acid (CHDA) as the dicarboxylic acid component, and 15.37 g of bis(p-aminocyclohexyl)methane (PACM50) and 92.34 g of 1,10-decanediamine (DDA) as the diamine component are used, respectively.

### Example 10

According to the composition as listed in Table 1, a copolymerized polyamide resin is prepared in the same manner as in Example 1 except that 89.71 g of terephthalic acid (TPA) and 10.33 g of 1,4-cyclohexanedicarboxylic acid (CHDA) as the dicarboxylic acid component, and 15.37 g of bis(p-aminocyclohexyl)methane (PACM50) and 92.34 g of 1,10-decanediamine (DDA) as the diamine component are used, respectively.

TABLE 1

| | | Examples | | | | | | | | | |
|---|---|---|---|---|---|---|---|---|---|---|---|
| Monomers | | 1 | 2 | 3 | 4 | 5 | 6 | 7 | 8 | 9 | 10 |
| Diacid | TPA (mol %) | 100 | 100 | 100 | — | — | — | 100 | 100 | 10 | 90 |
| | CHDA (mol %) | — | — | — | 100 | 100 | 100 | — | | 90 | 10 |
| Diamine | PACM50 (mol %) | 10 | 10 | — | 10 | 5 | — | — | 15 | 12 | 12 |
| | PACM20 (mol %) | — | — | — | — | — | 10 | 10 | — | — | — |
| | MACM (mol %) | — | — | 10 | — | — | — | — | — | — | — |
| | DDA (mol %) | 90 | — | 90 | — | — | — | — | 85 | 88 | 88 |
| | DDDA (mol %) | — | 90 | — | 90 | 95 | 90 | 90 | — | — | — |

| | |
|---|---|
| Diacid:Diamine (mole ratio) | 1:1.015 |

### Comparative Example 1

According to the composition as listed in Table 2, a monomer mixture comprising 99.68 g of terephthalic acid (TPA) as a dicarboxylic acid component, and 104.94 g of 1,10-decanediamine (DDA) as a diamine component, 2.20 g of benzoic acid as an end capping agent, 0.21 g of sodium hypophosphinate as a catalyst and 138 ml of distilled water are placed in a 1 L autoclave, which in turn is filled with nitrogen. Next, after stirring the components at 130° C. for 60 minutes, the mixture is heated to 250° C. for 2 hours and left for 3 hours at a pressure of 25 kgf/cm², followed by decreasing the pressure to 15 kgf/cm² and reacting the mixture for 1 hour. After flashing the mixture, it is separated into water and a polyamide pre-copolymer. The separated polyamide pre-copolymer (intrinsic viscosity [η]=about 0.25 dL/g) is put into a tumbler type reactor, and is subject to the solid state polymerization at 230° C. for 6 hours. Then, the polyamide pre-copolymer is cooled slowly to ambient temperatures to obtain a copolymerized polyamide resin.

### Comparative Example 2

According to the composition as listed in Table 2, a copolymerized polyamide resin is prepared in the same manner as in Comparative Example 1 except that 94.44 g of 1,10-decanediamine (DDA) and 12.20 g of 1,12-dodecanediamine (DDDA) instead of 104.94 g of 1,10-decanediamine (DDA) as the diamine component are used, respectively.

### Comparative Example 3

According to the composition as listed in Table 2, a copolymerized polyamide resin is prepared in the same manner as in Comparative Example 1 except that 122.03 g of 1,12-dodecanediamine (DDDA) instead of 104.94 g of 1,10-decanediamine (DDA) as the diamine component is used.

### Comparative Example 4

According to the composition as listed in Table 2, a copolymerized polyamide resin is prepared in the same manner as in Comparative Example 1 except that 103.31 g of 1,4-cyclohexanedicarboxylic acid (CHDA) instead of 99.68 g of terephthalic acid (TPA) as the dicarboxylic acid component is used.

### Comparative Example 5

According to the composition as listed in Table 2, a copolymerized polyamide resin is prepared in the same manner as in Comparative Example 1 except that 101.26 g of 1,10-decanediamine (DDA), and 4.48 g of bis(p-aminocyclohexyl)methane (PACM50) having a content of trans-trans isomer of 50.7 wt %, a content of trans-cis isomer of 38.4 wt %, and a content of cis-cis isomer of 10.9 wt % instead of 104.94 g of 1,10-decanediamine (DDA) as the diamine component are used, respectively.

TABLE 2

| | | Comparative Examples | | | | |
|---|---|---|---|---|---|---|
| Monomers | | 1 | 2 | 3 | 4 | 5 |
| Diacid | TPA (mol %) | 100 | 100 | 100 | — | 100 |
| | CHDA (mol %) | — | — | — | 100 | — |
| Diamine | PACM50 (mol %) | — | — | — | — | 3.5 |
| | DDA (mol %) | 100 | 90 | — | 100 | 96.5 |
| | DDDA (mol %) | — | 10 | 100 | — | — |

| | |
|---|---|
| Diacid:Diamine (mole ratio) | 1:1.015 |

### EXPERIMENTAL EXAMPLE

The polyamide resins prepared in Examples and Comparative Examples are evaluated with respect to melting temperature, crystallization temperature, glass transition temperature, melt enthalpy, crystallization enthalpy, intrinsic viscosity, fluidity and discoloration resistance by the following methods. Results are shown in Tables 3 and 4.

Property Evaluation

(1) Melting temperature (Tm), crystallization temperature (Tc) and glass transition temperature (Tg) (unit: ° C.): Melting temperature (Tm), crystallization temperature (Tc) and glass transition temperature (Tg) of the polyamide resins obtained after solid state polymerization in Examples and Comparative Examples using a differential scanning calorimeter (DSC). The DSC is a Q20 instrument (TA Co., Ltd.). For measurement of crystallization temperature, a 5 mg to 10 mg of specimen is dried (to 3,000 ppm or less of moisture) at 80° C. for 4 hours in a vacuum, heated from 30° C. to 400° C. at a rate of 10° C./min in a nitrogen atmosphere, and then left at 400° C. for 1 minute. Then, the specimen is cooled at a rate of 10° C./min to obtain an exothermic peak, from which crystallization temperature is measured. Further, glass transition temperature and melting temperature are measured from transition temperature and a maximum point of an endothermic peak obtained while the specimen is heated to 400° C. at a rate of 10° C./min (2nd scan) after the specimen is maintained at 30° C. for 1 minute after measurement of the crystallization temperature, respectively.

(2) Melt enthalpy and crystallization enthalpy (unit: J/g): Crystallization enthalpy is obtained by integration of the area of the exothermic peak, and melting enthalpy is obtained by integration of the area of the endothermic peak.

(3) Intrinsic viscosity (unit: dL/g): The prepared polyamide resin was dissolved to a concentration of 0.5 g/dl in a 98% sulfuric acid solution, followed by measurement of intrinsic viscosity at 25° C. using an Ubbelohde viscometer.

(4) Brightness (L*): A colorimeter is used to measure a L* value according to ASTM D1209.

(5) Discoloration resistance: Yellowness Index change (ΔYI) is evaluated according to Equation 1:

Color change (ΔYI)=YI after scorch testing−YI before scorch testing, [Equation 1]

wherein YI before scorch testing is a Yellowness Index (YI) value of the prepared copolymerized polyamide resin measured according to ASTM D1209, and YI after scorch testing is a YI value of the copolymerized polyamide resin after scorch testing conducted by leaving the copolymerized polyamide resin in a convection oven at about 200° C. for about 1 hour.

TABLE 3

| | Examples | | | | | | | | | |
|---|---|---|---|---|---|---|---|---|---|---|
| | 1 | 2 | 3 | 4 | 5 | 6 | 7 | 8 | 9 | 10 |
| Melting temperature (° C.) | 302 | 290 | 301 | 320 | 325 | 318 | 288 | 294 | 312 | 300 |
| Melt enthalpy (J/g) | 53 | 50 | 49 | 85 | 95 | 83 | 48 | 40 | 75 | 48 |
| Crystallization | 274 | 255 | 273 | 290 | 295 | 287 | 253 | 260 | 275 | 270 |
| temperature (° C.) | | | | | | | | | | |
| Crystallization enthalpy | 54 | 49 | 48 | 37 | 45 | 34 | 45 | 40 | 40 | 50 |
| (J/g) | | | | | | | | | | |
| Glass transition | 129 | 115 | 127 | 114 | 109 | 113 | 115 | 130 | 116 | 126 |
| temperature (° C.) | | | | | | | | | | |
| Intrinsic viscosity (dL/g) | 0.90 | 0.87 | 0.86 | 0.86 | 0.84 | 0.81 | 0.85 | 0.86 | 0.88 | 0.83 |
| YI before Scorch testing | 96.0 | 95.8 | 96.2 | 95.8 | 95.1 | 96.1 | 95.7 | 95.0 | 96.0 | 95.6 |
| YI after Scorch testing | 90.3 | 89.5 | 88.5 | 92.1 | 91.3 | 90.8 | 88.4 | 89.0 | 92.1 | 91.1 |
| YI change before and after | 8.5 | 10 | 11.8 | 4.9 | 6.5 | 6.7 | 11 | 10.5 | 5.1 | 7.9 |
| scorch testing (ΔYI) | | | | | | | | | | |

TABLE 4

| | Comparative Examples | | | | |
|---|---|---|---|---|---|
| | 1 | 2 | 3 | 4 | 5 |
| Melting temperature | 312 | 306 | 297 | 348 | 310 |
| (° C.) | | | | | |
| Melt enthalpy (J/g) | 115 | 52 | 90 | 41 | 81 |
| Crystallization | 283 | 275 | 272 | 320 | 278 |
| temperature (° C.) | | | | | |
| Crystallization enthalpy | 80 | 49 | 75 | 31 | 50 |
| (J/g) | | | | | |
| Glass transition | 120 | 115 | 118 | 120 | 123 |
| temperature (° C.) | | | | | |
| Intrinsic viscosity (dL/g) | 0.86 | 0.86 | 0.82 | 0.81 | 0.85 |
| YI before Scorch testing | 95.2 | 95.8 | 96.0 | 94.0 | 95.5 |
| YI after Scorch testing | 75.0 | 78.3 | 80.1 | 85.1 | 76.0 |
| YI change before and | 28.8 | 24 | 22.3 | 12.8 | 19.5 |
| after scorch testing | | | | | |
| (ΔYI) | | | | | |

It can be seen that these copolymerized polyamide resins according to the present invention exhibit excellent heat resistance, processability, discoloration resistance, and the like from the above results, and these resins are a crystalline polyamide resin from the results of crystallization enthalpy/temperature.

In contrast, for the Comparative Examples, it can be seen that the polyamide resins exhibit deteriorated high-temperature discoloration resistance and deteriorated processability due to a high melting temperature.

Many modifications and other embodiments of the invention will come to mind to one skilled in the art to which this invention pertains. Therefore, it is to be understood that the invention is not to be limited to the specific embodiments disclosed and that such modifications and other embodiments are intended to be included within the scope of the appended claims.

What is claimed is:

1. A copolymerized polyamide resin including a polymer of a monomer mixture comprising a dicarboxylic acid component and a diamine component including about 4 mol % to about 20 mol % of an alicyclic diamine represented by Formula 1: 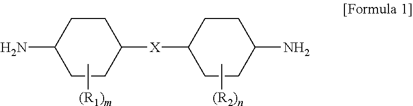
wherein, R₁ and R₂ are the same or different and are each independently a C₁ to C₅ alkyl group or a C₆ to C₁₀ aryl group, X is a C₁ to C₁₀ hydrocarbon group, and m and n are the same or different and are each independently an integer from 0 to 4,
wherein the polyamide resin has a melting temperature (Tm) from about 280 to about 330° C., and a crystallization temperature (Tc) from about 250 to about 300° C.

2. The copolymerized polyamide resin according to claim 1, wherein the dicarboxylic acid component comprises a C₈ to C₂₀ aromatic dicarboxylic acid, a C₆ to C₂₀ alicyclic dicarboxylic acid, or a mixture thereof.

3. The copolymerized polyamide resin according to claim 1, wherein the diamine component further comprises a C₄ to C₂₀ linear aliphatic diamine, a C₄ to C₂₀ branched aliphatic diamine, or a mixture thereof.

4. The copolymerized polyamide resin according to claim 1, wherein the alicyclic diamine represented by the Formula 1 includes a trans-trans isomer in an amount of about 15 to about 55 wt %, a trans-cis isomer in an amount of about 30 to about 55 wt %, and a cis-cis isomer in an amount of no more than about 35 wt %.

5. The copolymerized polyamide resin according to claim 1, wherein the copolymerized polyamide resin has a mole ratio of the dicarboxylic acid component and the diamine component (dicarboxylic acid component/diamine component) of about 0.95 to about 1.15.

6. The copolymerized polyamide resin according to claim 1, wherein the copolymerized polyamide resin has a terminal group encapsulated with an end capping agent comprising an aliphatic carboxylic acid, an aromatic carboxylic acid, or a mixture thereof.

7. The copolymerized polyamide resin according to claim 1, wherein the copolymerized polyamide resin has a glass transition temperature (Tg) from about 105 to about 135° C., a melt enthalpy from about 20 to about 100 J/g, and a crystallization enthalpy from about 20 to about 60 J/g.

8. The copolymerized polyamide resin according to claim 1, wherein the copolymerized polyamide resin has an intrinsic viscosity from about 0.5 to about 1.5 dL/g, and a Yellowness Index change (ΔYI) according to Equation 1 from about 4 to about 12:
Color change (ΔYI)=YI after scorch testing−YI before scorch testing, [Equation 1]
wherein YI before scorch testing is a Yellowness Index (YI) value of the prepared copolymerized polyamide resin measured according to ASTM D1209, and YI after scorch testing is a YI value of the copolymerized polyamide resin after scorch testing conducted by leaving the copolymerized polyamide resin in a convection oven at about 200° C. for about 1 hour.

9. A method for preparing a copolymerized polyamide resin comprising:
polymerizing a monomer mixture comprising a dicarboxylic acid component, and a diamine component including about 4 mol % to about 20 mol % of an alicyclic diamine represented by the Formula 1: 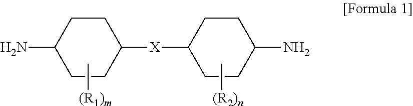
wherein, R₁ and R₂ are the same or different and are each independently a C₁ to C₅ alkyl group or a C₆ to C₁₀ aryl group, X is a C₁ to C₁₀ hydrocarbon group, and m and n are the same or different and are each independently an integer from 0 to 4,
wherein the polyamide resin has a melting temperature (Tm) from about 280 to about 330° C., and a crystallization temperature (Tc) from about 250 to about 300° C.

10. The method for preparing a copolymerized polyamide resin according to claim 9, comprising polymerizing the monomer mixture to obtain a prepolymer; and performing a solid state polymerization of the prepolymer.

11. The method for preparing a copolymerized polyamide resin according to claim 10, wherein the solid state polymerization comprises heating the prepolymer to a temperature of about 150 to about 280° C.

12. A molded article formed from the copolymerized polyamide resin according to claim 1.

13. The molded article according to claim 12, wherein the molded article is an LED reflector.

14. The molded article according to claim 12, wherein the molded article is a connector for electrical and electronic products.

15. The molded article according to claim 12, wherein the molded article is an exterior cladding for electrical and electronic products.
